(19) United States
(12) Patent Application Publication
(10) Pub. No.: US 2020/0252604 A1
(43) Pub. Date: Aug. 6, 2020

(54) ALIGNMENT TARGET AND METHOD FOR ALIGNING A CAMERA

(71) Applicant: SICK AG, Waldkirch (DE)

(72) Inventors: Florian SCHNEIDER, Waldkirch (DE); Denise BERTZ, Waldkirch (DE)

(21) Appl. No.: 16/777,143

(22) Filed: Jan. 30, 2020

(30) Foreign Application Priority Data
Feb. 5, 2019 (DE) 102019102783.7

(51) Int. Cl. H04N 17/00; G01B 11/27; G06T 7/80; H04N 5/232

(52) U.S. Cl. CPC H04N 17/002; H04N 5/23299; G06T 7/80; G01B 11/272

(57) ABSTRACT

An alignment target (16) for aligning a camera (10) is provided, said alignment target (16) having a plurality of triangular contrast marks (18, 20) that are arranged in a row. In this respect, a tip of a triangular shape of at least one contrast mark (18) faces upward and at least one contrast mark (20) faces downward.

The invention relates to an alignment target and to a method for aligning a camera, in particular a line scan camera, in accordance with the preambles of the respective independent claim.

Cameras are used in industrial applications in a variety of ways to automatically detect object properties, for example for an inspection or a measurement of objects. In this respect, images of the object are recorded and are evaluated in accordance with the task by image processing methods. A further use of cameras is the reading of codes. Objects with the codes located thereon are recorded with the aid of an image sensor, the code regions are identified in the images, and are then decoded. Camera-based code readers also cope without problem with different code types than one-dimensional barcodes which also have a two-dimensional structure like a matrix code and provide more information. The automatic detection of the text of printed addresses, (optical character recognition, OCR) or of handwriting is also a reading of codes in principle. Typical areas of use of code readers are supermarket cash registers, automatic parcel identification, sorting of mail shipments, baggage handling at airports, and other logistic applications.

Moving objects should be detected in a number of important applications. An example is the installation of the camera above a conveyor belt. The camera records images during the relative movement of the object stream on the conveyor belt and instigates further processing steps in dependence on the object properties acquired. Such processing steps comprise, for example, the further processing adapted to the specific object at a machine which acts on the conveyed objects or a change to the object stream in that specific objects are expelled from the object stream within the framework of a quality control or the object stream is sorted into a plurality of partial object streams. If the camera is a camera-based code reader, the objects are identified with reference to the affixed codes for a correct sorting or for similar processing steps.

In the case of moving objects, line scan cameras represent an established technology to assemble two-dimensional images piece by piece from the recorded lines in the course of the relative movement. Barcodes can be also be read directly in one movement by a line scan camera, with then the relative movement being used to guide the barcode into the reading field of the line scan camera at some point in time.

The camera should be adjusted or calibrated to satisfy its work. What is meant by this is the positioning and alignment of the camera, including an image sensor and optics, per se and with respect to its housing that have to be set or checked as part of the manufacture or final inspection, for example. However, it can also relate to the alignment in the specific installation situation of the application.

Hourglass targets are typically used for the adjustment of line scan cameras. FIG. 10a shows an example for such a conventional alignment target 100 having different contrast marks. Two sign bars 104 and a central feature 106 for the position of the optical axis are provided beside the two eponymous hourglasses 102.

FIG. 10b shows the associated sensor signal of an ideally adjusted system, i.e. the recorded intensity or gray scale in dependence on the position of the associated pixel along the line alignment. The signals of the two hourglasses 102 are very narrow. The central feature 106 for the position of the optical axis is at the center of the line. The sign bars 104 would only be visible in the sensor signal when there is a downward deviation from the ideal. In addition, both signals of the hourglasses 102 would be wider in a non-perfectly adjusted system. They would be equally wide among one another with a parallel offset. They differ from one another in the case of an obliquely aligned system.

A disadvantage of the conventional alignment target 100 is that the signal width is very difficult to evaluate in the ideally aligned case. The finer the structures, the greater the influence of the object imaging performance.

DE 10 2015 119 707 B3 discloses a method of aligning a laser scanner. A reference object is scanned for this purpose that has a plurality of strip-shaped markings, including a triangle, that are provided double in a point mirrored arrangement.

An optical positioning method is known from WO 2012/048420 A1 that uses a target having a plurality of trapezoidal marks.

JP 2005/274272 A relates to the calibration of a line scan camera. An arrangement of two triangles mirrored at the vertical center line are used as a target here.

The paper of Su, Daobilige et al. “Improved Cross-Ratio Invariant-Based Intrinsic Calibration of A Hyperspectral Line-Scan Camera.” Sensors 18.6 (2018): 1885 describes a method of detecting the intrinsic parameters of a line scan camera. A row of triangles is provided in two sections perpendicular to one another as the calibration target.

It is therefore the object of the invention to improve the alignment of a camera using an alignment target.

This object is satisfied by an alignment target and by a method for aligning a camera in accordance with the respective independent claim. The camera is preferably a line scan camera. It would also be conceivable to use a linear part region of a matrix camera for the alignment. The alignment target has a plurality of triangular contrast marks. Additional contrast marks of a different geometry are conceivable, but not necessary, that is are also preferably not provided. The contrast marks are arranged in a row that is called horizontal here. This is in relation to a usual upright position of the camera and of the alignment target, but is not to be understood as restrictive if a rotation out of the horizontal is desired.

The invention starts from the basic idea that both orientations, to the top and to the bottom, are provided among the triangles. There are consequently respective groups of triangles, one facing upward and one downward. The total number of triangles and the number of triangles in the two groups having an upward or downward orientation are parameters in the design of the alignment target.

The invention has the advantage that the evaluation of the camera signal that is generated on the recording of the alignment target has particularly little dependence on the imaging quality of the optics of the camera. The triangular contrast patterns in their particular arrangement result in wide peaks in the camera signal and this increased width can be evaluated substantially more robustly and exactly. Correlation methods or approximation methods can be used due to the high number of features of the alignment target to carry out even more stable and thus more exact evaluations. The number of features can here be influenced by the number of triangular contrast marks.

At least some contrast marks, in particular all of the contrast marks, preferably have the shape of an isosceles triangle. This symmetry simplifies the evaluation since the center position of a line extending horizontally through the triangle does not depend on the height at which it intersects the triangle. The angle of the isosceles triangles, that is graphically how flat or acute the isosceles triangle is, remains a still selectable parameter.

At least some contrast marks, in particular all of the contrast marks, preferably have a mutually congruent shape. The contrast marks therefore have the same triangular geometry among one another, with one group being vertically mirrored with respect to the other. The signals from the individual contrast marks are thus equivalent to one another and can be evaluated particularly easily and robustly.

The contrast marks are preferably aligned at the same level in the row. This means that there is a horizontal axis that extends through the same characteristic point of the triangles at least within a group, for instance the base line, the tip, or the center of mass. With congruent triangles, a horizontal axis runs through the tips of the one group and along the base line of the other. The triangles are additionally preferably equally spaced apart from one another.

The peaks of the contrast marks preferably face alternatingly upward and downward. This implies that the groups differ in number by at most one contrast mark.

In the method in accordance with the invention, the alignment of a camera, in particular of a line scan camera, takes place using an alignment target in accordance with the invention. Alignment means that the adjustment required therefor is localized and/or checked. An image of at least one line of the alignment target is recorded. With a line scan camera, this is a total image, with a lateral cropping remaining conceivable; with a matrix camera, a corresponding part region can be selected. The contrast marks are localized in the image. This is easily possible due to the predefined clear intensity difference at the margins and due to the particularly large or particularly small reflection capability or remission capability of the contrast marks since corresponding extremes and flanks are formed in the intensity of the camera signal. The width of the contrast marks in the direction of the line is determined. As long as the same measure is used for the contrast marks, the specific measure is not important, for a full width at half maximum of a peak in the camera signal generated by the contrast mark. The alignment is considered as correct when all the widths agree, with a defined tolerance being able to be permitted.

The orientation of the camera is preferably changed until all the widths agree. This can take place manually or automatically using a corresponding electronic actuator. There are five degrees of freedom in principle here: A horizontal displacement a, a vertical displacement b, a horizontal tilting or squinting α, a vertical tilting or squinting β, and a rotation χ about the optical axis of the camera. The alignment target makes evaluations possible that provide conclusions on the degree of freedom still to be adapted and on the degree of the required correction, as will be explained more exactly in the following. It can use an automatic regulation; at least one of the evaluations is also possible quickly and intuitively for a human fitter.

The position of the contrast marks is preferably determined in the direction of the line. An evaluation therefore takes place as to where the contrast marks are located along the recorded line. For this purpose, only the corresponding peaks are localized, for example as a position of an extreme, as an average of all the values of the peak that satisfy a threshold criterion, or as an average between the two flanks at the margin of the detected contrast mark.

The respective width is preferably determined as a function of the position. The respective width of a detected contrast mark is thus associated with the position and a function is sought that reflects the connection in accordance with these interpolation points as faithfully as possible, in particular by a straight line fit or a straight regression line.

The function is preferably formed in two groups, once for those with upwardly facing peaks of the triangular contrast marks and once for the downwardly facing peaks of the triangular contrast marks. Two straight line sections are then in particular produced with a straight line fit and their mutual positions and alignments make it very easily possible to recognize and also to quantify degrees of freedom still to be aligned.

The alignment is considered correct when the width forms a horizontal axis as the function of the position. This is a first criterion how the function or, in the case of two groups, the two functions, is/are evaluated. This is in particular able to be checked very quickly and intuitively on a display for a human fitter. It can thus be very easily detected, for instance for two straight line sections of the two groups, whether they form two horizontal axes disposed on one another. Deviations as part of tolerances are conceivable and are a measure for the residual error of the alignment.

A misalignment in the form of a rotation (χ) about the optical axis of the camera is preferably determined from an angle of the function against the horizontal axis. If there is still a misalignment in this degree of freedom, the two straight line sections of the two groups form a cross and the angle between the straight line sections is a measure for the rotation χ. On a common evaluation without groups of the upwardly and downwardly facing triangles, a straight line can no longer be determined or can only be fit with a large error.

A misalignment in the form of a horizontal displacement (a) or a horizontal tilt (α) is preferably determined from the center position of the calibration marks along the line. Graphically, the still not yet correctly aligned camera looks to the right or left past the target. The center position of the calibration marks can be determined from the individual positions of the calibration marks, for example as their mean value.

A misalignment in the form of a vertical displacement (b) or a vertical tilt (β) is preferably determined from a parallel offset of the function of the two groups. Graphically, the still not yet correctly aligned camera looks to the top or bottom past the target. In principle, the alignment corresponds to the horizontal alignment. However, no center position of the calibration marks is determined, but a parallel offset between the two straight line sections that were fit to the widths of the calibration marks is rather the measure for a misalignment still present in these degrees of freedom.

The alignment target is preferably recorded with multiple parallel shifts at different distances. For on a recording from only one distance, it is not yet possible to distinguish between a displacement a, b and a tilt or a squint α, β. Care must be taken that the alignment target is shifted in parallel for its orientation change has an effect on said five degrees of freedom and the camera should be able to assume that this influence is absent. The alignment target is traveled on a rail for this purpose, for example.

A straight line fit is preferably carried out via the center position and/or the parallel offset for different distances and a horizontal and/or vertical displacement a, b and/or tilt α, β is/are determined from the gradient or axial section of the fitted straight line. This is a simple process to evaluate the additional information from the recordings of the alignment target at different distances and to quantify the influence of both the displacement a, b and the tilt α,β. In this respect, the distance of zero is preferably assumed in the front main objective plane of the camera.

The invention will be explained in more detail in the following also with respect to further features and advantages by way of example with reference to embodiments and to the enclosed drawing. The Figures of the drawing show in:

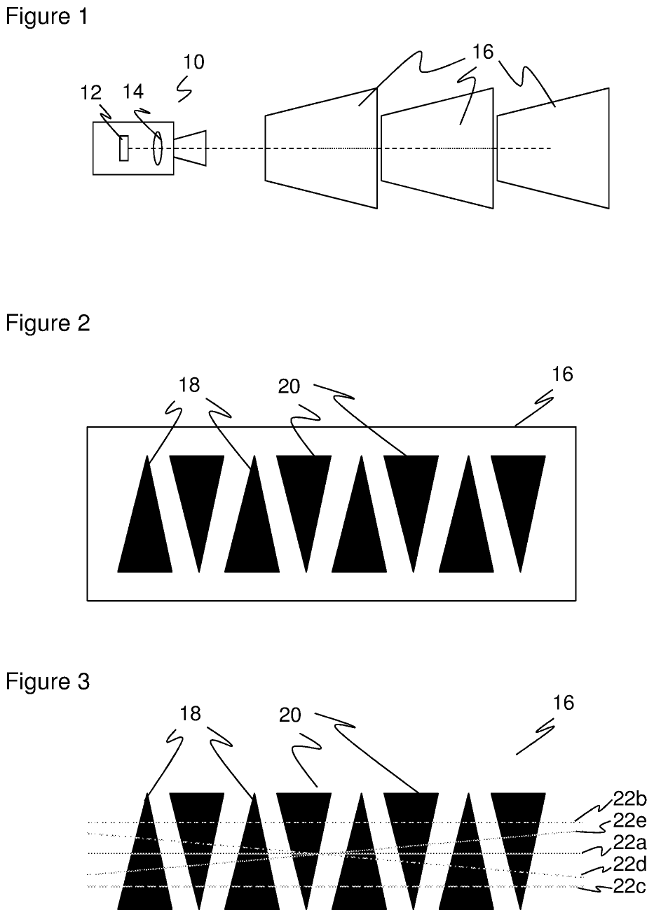

FIG. 1 a schematic view of a camera with alignment targets at a plurality of distances;

FIG. 2 a plan view of an embodiment of an alignment target with triangular contrast marks alternatingly being upside down;

FIG. 3 a representation of some exemplary alignments of the linear detection zone of a camera with respect to the alignment target in accordance with FIG. 2;

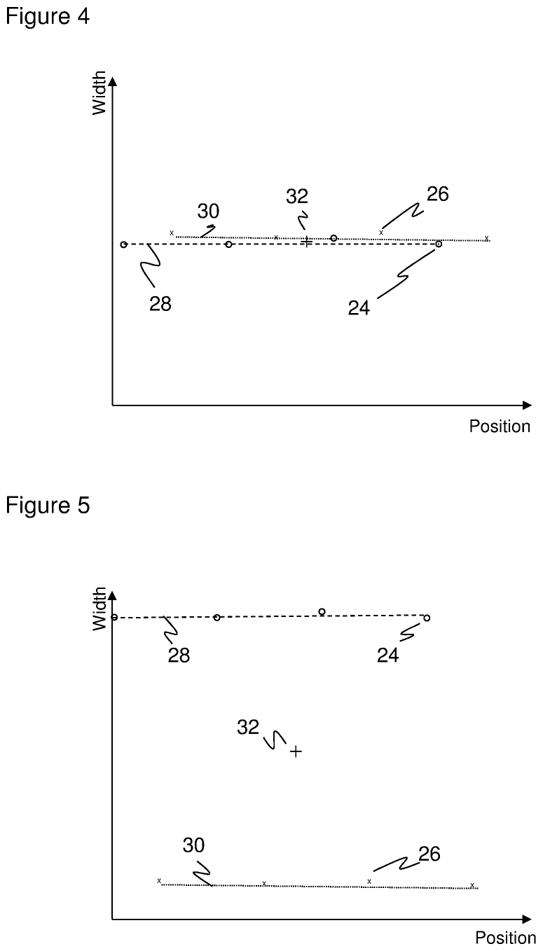

FIG. 4 a representation of the dependence of the width of the detected triangular contrast marks on the position along the camera line for the case of a correctly adjusted system;

FIG. 5 a representation in accordance with FIG. 4 for the case of vertical alignment errors;

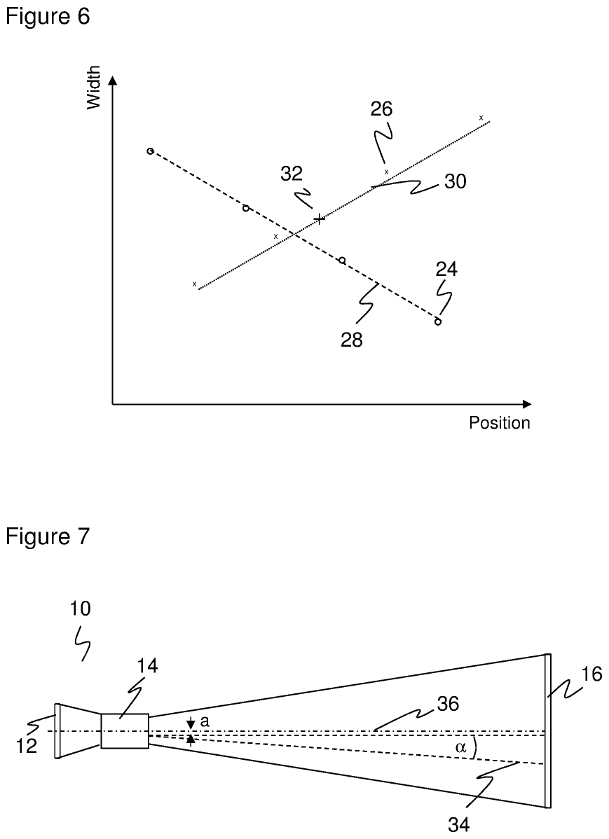

FIG. 6 a representation in accordance with FIG. 4 for the case of a rotation of the camera;

FIG. 7 a plan view of a camera and of an alignment target to illustrate horizontal alignment errors;

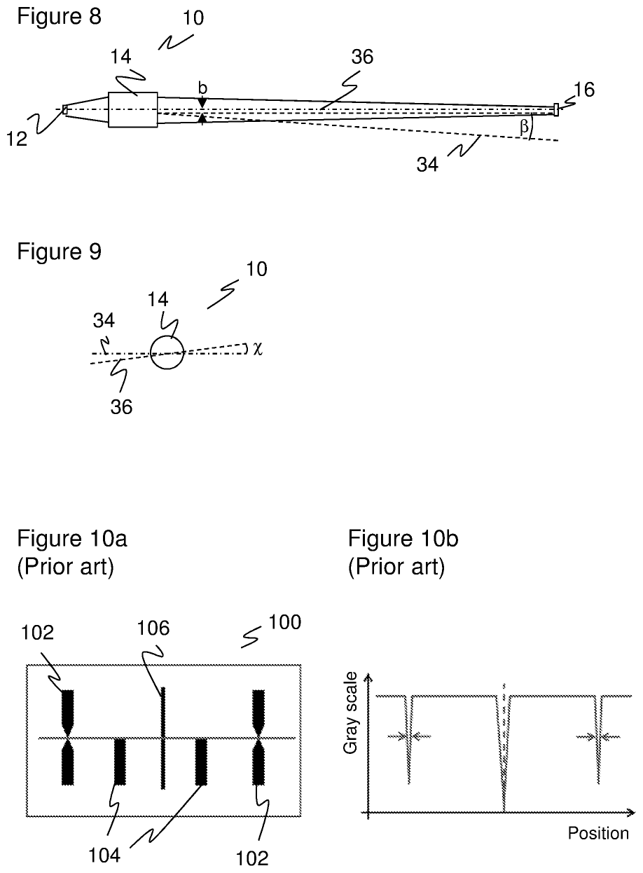

FIG. 8 a side view of a camera and of an alignment target to illustrate horizontal alignment errors;

FIG. 9 a front view of a camera to illustrate a rotation of the camera;

FIG. 10a a representation of a conventional hourglass alignment target; and

FIG. 10b a representation of the sensor signal of the hourglass alignment target in accordance with FIG. 10a recorded by a correctly adjusted camera.

FIG. 1 shows a schematic view of a camera 10 that should, for example, be aligned in the course of manufacture or also on the assembly at the site of use or whose alignment is to be checked. The camera 10 is preferably a line scan camera and is only shown very schematically with an image sensor 12, for example a pixel array or a pixel matrix, and with an objective 14. Some design and use possibilities of the camera 10, that are not exclusive, have been named in the introduction.

An alignment target 16 is presented to the camera 10 at different known distances during the alignment. The reference point zero of the distance is preferably the front main plane of the objective 14. The alignment target 16 is displaced in parallel here. The camera 10 records a line transversely over the alignment target 16, i.e. perpendicular to the plane of the paper of FIG. 1, for every distance. These camera signals, that in a manner similar to FIG. 10b represent an intensity signal or a gray scale signal, are evaluated in the manner described in the following to improve or check the alignment of the camera 10.

FIG. 2 shows a plan view of an embodiment of the alignment target 16. Hourglasses as conventionally in accordance with FIG. 10a are not used as contrast marks, but rather triangles 18, 20. The contrast marks are black in this embodiment. It is generally sufficient if the contrast marks clearly differ from the environment or from the background. Reflectors or white regions can therefore also be provided against a dark background or any other desired high contrast differences can be provided.

The triangles 18, 20 are isosceles and are arranged in two groups, namely a group of triangles 18 with their tips aligned upwardly and a group of triangles 20 with their tips aligned downwardly. The triangles 18, 20 are isosceles, are congruent with one another, and alternate in their alignment. They are additionally horizontally aligned and are arranged at a uniform distance from one another. The alignment target 16 thus has a whole series of regularities and symmetries. Remaining design parameters include the gradient of the triangles 18, 20, that is the angles of the limbs with respect to the base line, and the number of triangles 18, 20 in the camera field of vision. In other embodiments, only some of said regular and symmetrical properties of the triangles 18, 20 are implemented, but with at least upwardly and downwardly facing triangles 18, 20 being present in a row arrangement.

FIG. 3 again shows the alignment target 16 and some examples of how the line 22a-e recorded by the camera 10 extends through the alignment target 16 in dependence on the alignment of the camera 10. A correct alignment is present with a horizontally and centrally extending line 22a. With a line 22b displaced upwardly in parallel or with a line 22c displaced downwardly in parallel, there is a vertical displacement b and/or a vertical tilt β. A line 22d rotated clockwise and a line 22e rotated counter clockwise are furthermore conceivable. In this case, the camera 10 is rotated by an angle χ about its optical axis. In addition, a horizontal displacement a and a tilt α are conceivable, which is expressed by the triangles 18, 20 not being recorded in a horizontally centered manner. The different alignment errors can occur individually or superposed.

A possible evaluation of the camera signals of the alignment target 16 will now be described with reference to FIGS. 4 to 6. The width of the detected triangles 18, 20 is determined and is assigned to their positions for this purpose. The triangles generate peaks in the camera signal, and indeed maxima at contrast marks having a particularly high reflection capability or remission capability and minima at contrast marks having a particularly small reflection capability or remission capability. The corresponding peaks in the camera signal can be easily localized using threshold criteria or the like. The peaks and their flanks are very pronounced due to the separately created contrast difference of the contrast marks. No particular problems therefore result in determining the position and width of such a peak, for instance counting pixels for the width that satisfy a threshold criterion and using their center positions as the position.

FIG. 4 shows an example of the widths of the triangles 18, 20 in dependence on their position with an ideal alignment of the camera 10. This corresponds to the horizontal and centered line 22a in FIG. 3. The measurement points 24 for the four upwardly facing triangles 18 are entered with “o”; the measurement points for the four downwardly facing triangles 20 correspondingly with “x”. A dashed line is a first compensation straight line 28 for the measurement points 24 of the upwardly facing triangles 18; a solid line is a second compensation straight line 30 for the measurement points 26 of the downwardly facing triangles 20. A horizontal center 32 results, for example, as a center of the positions determined with respect to all the triangles 18, 20.

In the aligned case, identical widths are detected for all the triangles 18, 20. Both compensation straight lines 28, 30 are therefore horizontally centered within the framework of tolerances and lie on one another. This is therefore the easily recognizable criterion for an aligned system and the deviations or alignment errors explained in the following can be read off equally simply. The horizontal alignment results in that the horizontal center 32 is centered in the line.

FIG. 5 shows a representation analog to FIG. 4, but now with an alignment error b, β of the camera 10 in the vertical direction. This corresponds to the situation of lines 22b-c displaced in parallel in FIG. 3. The two compensation straight lines 28, 30 have a parallel offset from one another whose amount quantifies the misalignment. This is due to the fact that the one group of triangles 18, 20 at the height of the line 22b-c displaced in parallel has a smaller width and the other group of triangles 20, 18 has a higher width.

FIG. 6 again shows a representation analog to FIG. 4, now with a rotation of the camera 10 about its optical axis. This corresponds to the rotated lines 22d-e in FIG. 3 and is expressed in FIG. 6 in that the two compensation straight lines 28, 30 intersect one another. The angle quantifies the alignment error χ. The alignment errors explained with respect to FIGS. 5 and 6 can also occur in superposed form and are then the compensation straight lines 28, 30, both offset and rotated.

FIGS. 7 to 9 again illustrate the different alignment errors, i.e. the displacements or offsets a, b and the tilts or the squint angles α, β, χ. FIG. 7 is a plan view and illustrates the horizontal displacement a and the horizontal tilt α. The actual horizontal alignment 34 can deviate from the desired ideal alignment 36 in a and/or α. A simplified camera representation of only the plane of the image sensor 12, of a very schematic objective 14, and of the alignment target 16 in one of the plurality of distances is shown here.

The squint angle α and the corresponding offset a are determined via the center alignment of the alignment target 16. The horizontal center 32 of the alignment target is known. The horizontal center position can be determined as a function of the distance after a plurality of recordings at different distances of the alignment target 16, with this function being fit as a straight line on the basis of optical principles. The gradient of the straight lines corresponds to the angle α and its point of intersection with the front main objective plane corresponds to the offset a. If the zero point is placed in the front main objective plane, a is the axial section of the straight line. So that this is also numerically correct, the respective measured horizontal center position in the object plane should also be given for the straight line fit in a suitable length unit such as millimeters. The conversion between the object plane and the image plane can take place via the known size of the alignment target 16 or of the triangles 18, 20.

FIG. 8 shows an associated side view to illustrate the vertical displacement b and the vertical tilt β and their correction. This is done in a very analog manner to the horizontal alignment. However, the horizontal center position is naturally not used here. The parallel offset of the two compensation straight lines 28, 30 shown in FIG. 5 or their individual deviation from the center is rather used as a measure for the deviation.

FIG. 9 shows an associated front view to illustrate a rotation χ about the optical axis as a remaining fifth alignment parameter. The recording of the alignment target at one single distance is sufficient for this alignment, but the plurality of camera recordings can also be used for an averaging or any other common evaluation. The rotation χ corresponds to the slanted position of the compensation straight lines 28, 30 in FIG. 6. As in the cases explained with reference to FIGS. 7 and 8, the imaging scale and the gradient of the triangles 18, 20 also have to be included for the calculation of the squint angle χ.

A distortion of the objective 14 due to a non-linear fit of the measured widths of the triangles 18, 20 can be determined and optionally corrected beyond the described alignments.

1. An alignment target for aligning a camera, said alignment target having a plurality of triangular contrast marks that are arranged in a row, with a tip of a triangular shape of at least one contrast mark facing upward and a tip of at least one further contrast mark facing downward.

2. The alignment target in accordance with claim 1, wherein the camera is a line scan camera,

3. The alignment target in accordance with claim 1,
wherein at least some contrast marks have the shape of an isosceles triangle.

4. The alignment target in accordance with claim 3,
wherein all of the contrast marks have the shape of an isosceles triangle.

5. The alignment target in accordance with claim 1,
wherein at least some contrast marks have a mutually congruent shape.

6. The alignment target in accordance with claim 5,
wherein all of the contrast marks have a mutually congruent shape.

7. The alignment target in accordance with claim 1,
wherein the contrast marks are aligned at the same level in the row.

8. The alignment target in accordance with claim 1,
wherein the peaks of the contrast marks face alternatingly upward and downward.

9. A method of aligning a camera, having an alignment target, said alignment target having a plurality of triangular contrast marks that are arranged in a row, with a tip of a triangular shape of at least one contrast mark facing upward and a tip of at least one further contrast mark facing downward, in which an image of at least one line of the alignment target is recorded, in which the contrast marks are localized in the image, in which
the width of the contrast marks is determined in the direction of the line, and in which an alignment is considered correct when all the widths agree.

10. The method in accordance with claim 9, wherein the camera is a line scan camera,

11. The method in accordance with claim 9,
wherein the orientation of the camera is changed until all the widths agree.

12. The method in accordance with claim 9,
wherein the position of the contrast marks is determined in the direction of the line.

13. The method in accordance with claim 12,
wherein the respective width is determined as the function of the position.

14. The method in accordance with claim 13,
wherein the function is formed in two groups, once for the upwardly facing peaks of the triangular contrast marks and once for the downwardly facing peaks of the triangular contrast marks.

15. The method in accordance with claim 13,
wherein the alignment is considered correct when the width forms a horizontal axis as the function of the position.

16. The method in accordance with claim 13,
wherein a misalignment in the form of a rotation about the optical axis of the camera is determined from an angle of the function against the horizontal axis.

17. The method in accordance with claim 9,
wherein a misalignment in the form of a horizontal displacement or a horizontal tilt is determined from the center position of the calibration marks along the line.

18. The method in accordance with claim 13,
wherein a misalignment in the form of a vertical displacement or a vertical tilt is determined from a parallel offset of the function of the two groups.

19. The method in accordance with claim 9,
wherein the alignment target is recorded with multiple parallel shifts at different distances.

20. The method in accordance with claim 19,
wherein a misalignment in the form of a horizontal displacement or a horizontal tilt is determined from the center position of the calibration marks along the line, and wherein a straight line fit is carried out for the center position and/or for the parallel offset for different distances and a horizontal and/or vertical displacement a, b and/or tilt is/are determined from the gradient or axial section of the fitted straight line.
